(19) United States
(12) Patent Application Publication
(10) Pub. No.: US 2024/0122127 A1
(43) Pub. Date: Apr. 18, 2024

(54) CULTIVATION GREENHOUSE

(71) Applicant: MITSUBISHI HEAVY INDUSTRIES, LTD., Tokyo (JP)

(72) Inventors: Shohei Akagi, Tokyo (JP); Keiichi Sato, Tokyo (JP); Yutaka Miyamoto, Tokyo (JP); Yoshitaka Shindo, Tokyo (JP)

(73) Assignee: MITSUBISHI HEAVY INDUSTRIES, LTD., Tokyo (JP)

(21) Appl. No.: 18/274,577

(22) PCT Filed: Jan. 27, 2022
(86) PCT No.: PCT/JP2022/003088

§ 371 Date: Jul. 27, 2023

(30) Foreign Application Priority Data
Jan. 29, 2021 (JP) 2021-012834

(51) Int. Cl. A01G 9/24; A01G 7/02; A01G 9/14

(52) U.S. Cl. CPC A01G 9/246; A01G 7/02; A01G 9/1469; A01G 9/247

(57) ABSTRACT

A cultivation greenhouse includes: an inner lining that forms a housing space for housing a plant to be a cultivation target, the inner lining tightly sealing the housing space; an outer lining that is disposed on an outer side of the inner lining to house the inner lining, the outer lining forming, with the inner lining, a circulation space for flowing outside air; and a circulation device that circulates air outside the outer lining into the circulation space and discharges the air to outside of the outer lining.

### FIELD

The present disclosure relates to a cultivation greenhouse.

### BACKGROUND

As a cultivation greenhouse for cultivating plants, there is a known configuration having a double-layered structure with an inner lining and an outer lining, for example, to increase a heat retention property. Since such a cultivation greenhouse with a double-layered structure has a high heat retention property, the inside of the inner lining becomes hot during the summer season. Therefore, there is a need for a configuration that is capable of properly adjusting the internal temperature. A configuration for adjusting the temperature by ventilating the inside of a cultivation greenhouse is disclosed in Patent Literature 1 or the like, for example.

### CITATION LIST

### Patent Literature

Patent Literature 1: Japanese Patent No. 6135027

### SUMMARY

### Technical Problem

In such a greenhouse with ventilation as described above, the wind speed around the plants may increase depending on the airflow rate during the ventilation, which may cause stress onto the plants. Therefore, there is a need for a cultivation greenhouse that is capable of properly adjusting the internal temperature while suppressing the stress on the plants.

The present disclosure is designed in view of the aforementioned circumstance, and it is an object thereof to provide a cultivation greenhouse that is capable of properly adjusting the internal temperature while suppressing the stress on the plants.

### Solution to Problem

A cultivation greenhouse according to the present disclosure includes: an inner lining that forms a housing space for housing a plant to be a cultivation target, the inner lining tightly sealing the housing space; an outer lining that is disposed on an outer side of the inner lining to house the inner lining, the outer lining forming, with the inner lining, a circulation space for flowing outside air; and a circulation device that circulates air outside the outer lining into the circulation space and discharges the air to outside of the outer lining.

### Advantageous Effects of Invention

According to the present disclosure, it is possible to provide the cultivation greenhouse that is capable of properly adjusting the internal temperature while suppressing the stress on the plants.

### BRIEF DESCRIPTION OF DRAWINGS

FIG. 1 is a front view illustrating an example of a cultivation greenhouse according to a first embodiment.

FIG. 2 is a sectional view of the example of the cultivation greenhouse, which illustrates a configuration taken along the A-A section in FIG. 1.

FIG. 3 is a front view illustrating an example of a cultivation greenhouse according to a second embodiment.

FIG. 4 is a sectional view of the example of the cultivation greenhouse, which illustrates a configuration taken along the A-A section in FIG. 1.

FIG. 5 is a sectional view illustrating an example of a cultivation greenhouse according to a third embodiment.

FIG. 6 is a front view illustrating an example of a cultivation greenhouse according to a fourth embodiment.

FIG. 7 is a sectional view of the example of the cultivation greenhouse, which illustrates a configuration taken along the C-C section in FIG. 6.

FIG. 8 is a flowchart illustrating a flow of control performed by a light-shielding control unit.

FIG. 9 is a table indicating examples of light-shielding states and control contents of light-shielding sheets.

### DESCRIPTION OF EMBODIMENTS

Hereinafter, embodiments of a cultivation greenhouse according to the present disclosure will be described with reference to the accompanying drawings. Note that the present invention is not limited by the embodiments. Also, the structural components in the following embodiments include those that are easily replaceable by those skilled in the art, or those that are substantially the same.

### First Embodiment

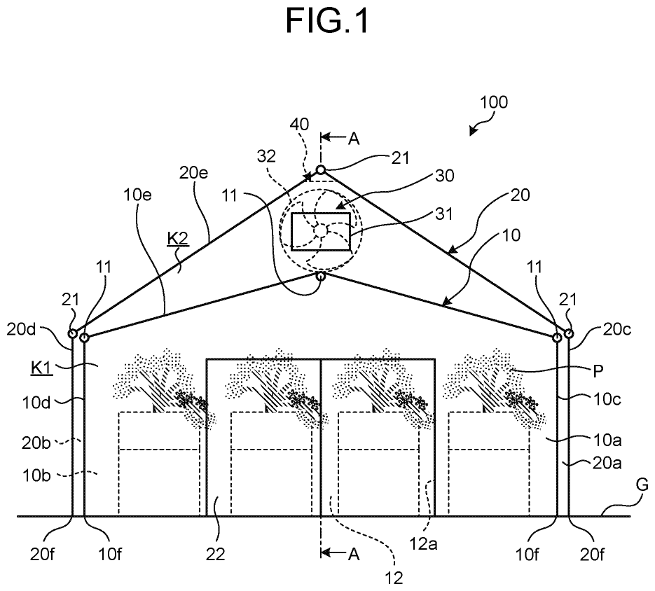

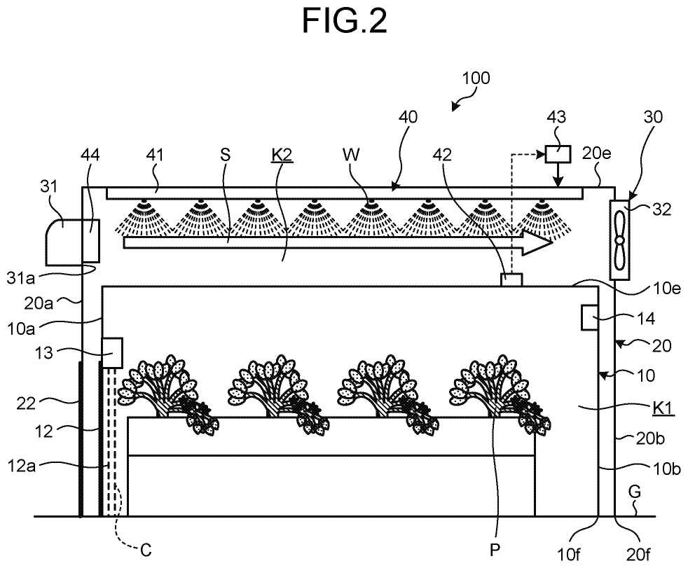

FIG. 1 is a front view illustrating an example of a cultivation greenhouse 100 according to a first embodiment. FIG. 2 is a sectional view of the example of the cultivation greenhouse 100, which illustrates a configuration taken along the A-A section in FIG. 1. The cultivation greenhouse 100 illustrated in FIG. 1 and FIG. 2 is built outdoors on a ground surface G, for example, and cultivates plants P mainly by bringing in natural light such as sunlight. The cultivation greenhouse 100 includes an inner lining 10, an outer lining 20, a circulation device 30, and a cooling device 40.

The inner lining 10 forms a housing space K1 for housing the plants P as cultivation targets. The inner lining 10 transmits light of wavelengths that allow the plants P to photosynthesize. The inner lining 10 is formed using transparent materials such as vinyl, glass, and the like, for example. The materials configuring the inner lining 10 are not limited to those mentioned above, and other materials may be used as long as those are the materials that transmit the light of the wavelengths that allow the plants P to photosynthesize. The inner lining 10 is disposed while being extended on a frame 11 serving as a framework. The inner lining 10 has a front face part 10a and a rear face part 10b to be gable ends, side face parts 10c, 10d, and a ceiling part 10e.

A lower end 10f of the inner lining 10 is fixed to the ground surface G by pipes, stakes, and the like, for example, such that no gap is formed between the ground surface G and itself. The lower end 10f of the inner lining 10 is sealed against the ground surface G such that there is no gap generated therebetween. As a result, the inner lining 10 forms a tightly closed configuration such that no air flow is formed between the inside and the outside of the housing space K1.

The inner lining 10 has a door 12 in the front face part 10a, for example. The door 12 may be disposed on the rear face part 10b or the side face parts 10c, 10d. The door 12, in a closed state, is configured to have no air flow generated inside and outside of the inner lining 10. On a portion in a face of the inner lining 10 facing the housing space K1 and above the door 12, an air curtain forming unit 13 is disposed. The air curtain forming unit 13, in a state where the door 12 is open, forms an air curtain C to block an opening area 12a of the inner lining 10. This makes it possible to prevent air flow from being formed over the inside and outside of the opening area 12a in a state where the door 12 is open.

In the inner lining 10, an air conditioning device 14 is disposed. The air conditioning device 14 adjusts the temperature of the housing space K1 in a supplementary manner. The air conditioning device 14 is disposed in the rear face part 10b of the inner lining 10, for example. The air conditioning device 14 is connected to an external outdoor unit (not illustrated) through the rear face part 10b and a rear face part 20b of the outer lining 20 by piping (not illustrated), for example.

The outer lining 20 is disposed on the outer side of the inner lining 10. The outer lining 20 transmits light of wavelengths that allow the plants P to photosynthesize. Like the inner lining 10, the outer lining 20 is formed using transparent materials such as vinyl, glass, and the like, for example. The materials configuring the outer lining 20 are not limited to those mentioned above, and other materials may be used as long as those are the materials that transmit the light of the wavelengths that allow the plants P to photosynthesize. The outer lining 20 is disposed while being attached to a frame 21 serving as a framework. The outer lining 20 has a front face part 20a and the rear face part 20b to be gable ends, side face parts 20c, 20d, and a ceiling part 20e.

A lower end 20f of the outer lining 20 is fixed to the ground surface G by pipes, stakes, and the like, for example, such that no gap is formed between the ground surface G and itself. The lower end 20f of the outer lining 20 is sealed against the ground surface G such that there is no air flow generated to and from the outside.

The outer lining 20 has a door 22 in the front face part 20a. In this case, the cultivation greenhouse 100 comes to have the door 22 of the outer lining 20 and the door 12 of the inner lining 10 disposed on the front side. The door 22 of the outer lining 20 and the door 12 of the inner lining 10 may be configured such that one does not open when the other is open, for example. The door 22, in a closed state, is configured to have no air flow generated inside and outside of the outer lining 20.

The inner lining 10 and the outer lining 20 are disposed to form a circulation space K2 between the ceiling part 10e of the inner lining 10 and the ceiling part 20e of the outer lining 20. In the present embodiment, the circulation space K2 allows air outside the outer lining 20 to circulate. The circulation space K2 is formed in a straight line direction from the front face part 20a side of the outer lining 20 to the rear face part 20b side.

Note that the front face part 20a and the rear face part 20b of the outer lining 20 may be configured to be directly connected to the ceiling part 10e of the inner lining 10. In that case, the front face part 10a and the rear face part 10b of the inner lining 10 may be omitted or may be provided as part of the front face part 20a and the rear face part 20b of the outer lining 20. This configuration makes it possible to secure the sealability of the circulation space K2.

In the present embodiment, each of the inner lining 10 and the outer lining 20 is sealed against the ground surface G. The double sealing of the inner lining 10 and the outer lining 20 prevents air outside the outer lining 20 from flowing into the inner lining 10.

The circulation device 30 circulates air outside of the outer lining 20 into the circulation space K2 and discharges the air to the outside of the outer lining 20. The circulation device 30 has an air intake unit 31 and an air discharge unit 32. The air intake unit 31 is provided at an area of the front face part 20a of the outer lining 20, which faces the circulation space K2. As the air intake unit 31, there may be a duct or the like provided in the front face part 20a, for example. The intake of outside air through the air intake unit 31 causes the outside air to flow into the circulation space K2.

The air discharge unit 32 is provided at an area of the rear face part 20b of the outer lining 20, which faces the circulation space K2. The air discharge unit 32 has an air discharge device such as a ventilation fan, for example. The air discharge unit 32 discharges the air in the circulation space K2 to the outside of the outer lining 20. The air discharge unit 32 is driven by a drive device, not illustrated.

Switching of starting and stopping the operations of the air discharge unit 32 may be performed manually by an operator, for example, or the temperature of the inner lining 10 or the housing space K1 may be measured to enable automatic switching based on the measurement result. When automatically switching the operations of the air discharge unit 32, for example, the air discharge unit 32 may be configured to start the operation when the temperature of the inner lining 10 or the housing space K1 is equal to higher than a threshold and to stop the operation of the air discharge unit 32 of the air discharge unit 32 when the temperature is less than the threshold. Furthermore, the air discharge unit 32 may also be capable of adjusting the discharge amount per unit time in steps or continuously.

As for the air intake unit 31 and the air discharge unit 32, each of the opening areas is provided to be capable of being opened and closed. The air intake unit 31 and the air discharge unit 32 can be in an open state, when allowing outside air to flow into the circulation space K2 in the summer season and the like, for example. In the winter season and the like, for example, the air intake unit 31 and the air discharge unit 32 can be kept in a closed state. By closing the opening areas, the air intake unit 31 and the air discharge unit 32 can close the circulation space K2 such that there is no air flow generated to and from the outside of the outer lining 20.

At least one of the air intake unit 31 and the air discharge unit 32 may be disposed at a plurality of positions. Furthermore, it is also possible to employ a configuration where the air intake unit 31 is disposed in the rear face part 20b, and the air discharge unit 32 is disposed in the front face part 20a.

The cooling device 40 cools the air circulating in the circulation space K2. The cooling device 40 supplies water to the circulation space K2 that is a path through which the air circulates. The cooling device 40 includes a spraying device 41, a temperature detection unit 42, a supply control unit 43, and a pad device 44.

The spraying device 41 supplies mist W, which is atomized water, to the circulation space K2. The spraying device 41 is attached to the ceiling part 20e of the outer lining 20, for example, and sprays the mist W downward from the ceiling part 20e. The spraying device 41 has jet ports of the mist W at a plurality of positions throughout the entirety from the front face part 20a side to the rear face part 20b side of the outer lining 20. Furthermore, the spraying device 41 may also be disposed at a plurality of positions between the side face parts 20c and 20d of the outer lining 20. This makes it possible to supply the mist W over the entire circulation space K2. Note that the spraying device 41 may be attached to the ceiling part 10e of the inner lining 10, and supplies the mist W upward from the ceiling part 10e. The temperature detection unit 42 detects the temperature inside the inner lining 10 or the housing space K1.

The supply control unit 43 controls the supply amount and supply timing of the mist W that is supplied from the spraying device 41. The supply control unit 43 controls the supply amount of the mist W by controlling the supply amount of the mist W supplied per unit time, for example. The supply control unit 43 controls the supply timing of the mist W based on the detection result of the temperature detection unit 42. For example, the supply control unit 43 can start supply of the mist W or increase the supply amount of the mist W, when the temperature in the inner lining 10 or the housing space K1 in the detection result of the temperature detection unit 42 is equal to or higher than a prescribed threshold. Furthermore, the supply control unit 43 can stop supply of the mist W or decrease the supply amount of the mist W, when the temperature in the inner lining 10 or the housing space K1 in the detection result of the temperature detection unit 42 is less than the prescribed threshold. The prescribed threshold can be set by conducting experiments, simulations, or the like, for example. Note that the supply amount and supply timing of the mist W supplied from the spraying device 41 may be adjusted manually by the operator, for example.

The pad device 44 is attached to an opening part 31a of the air intake unit 31, for example. The pad device 44 is a honeycomb structure made of a paper material or a configuration filled with a porous material such as non-woven fabric, fiber cloth, or the like, for example, which allows air from the opening part 31a to pass through the voids in the filling and water from the above the pad device 44 to pass through the surface of the filling. By disposing the pad device 44 in the opening part 31a with water flowing inside the filling, the water inside the pad device 44 can evaporate and cool the air passing through the voids. The pad device 44 is configured to supply water to the internal filling under the control of the supply control unit 43, for example.

Since the cultivation greenhouse 100 configured in the manner described above has a double-layered structure with the inner lining 10 and the outer lining 20, the heat retention property is increased in the winter season, for example. In the meantime, during the summer season, the temperature in the housing space K1 of the inner lining 10 may become hot due to sunlight and the like. In that case, the operator starts the operation of the air discharge unit 32 of the circulation device 30 in accordance with the temperature of the inner lining 10 and the like.

The air discharge unit 32 discharges the air in the circulation space K2 to the outside of the outer lining 20. In the present embodiment, when the air discharge unit 32 is operated, the vicinity of the air discharge unit 32 comes to be in a negative pressure, and the air in the circulation space K2 flows toward the air discharge unit 32, causing the entire circulation space K2 to be in a negative pressure. Due to the negative pressure, outside air is drawn from the air intake unit 31. Thus, in the present embodiment, as illustrated in FIG. 2, an air flow S is generated in the circulation space K2 by the operation of the air discharge unit 32. This air flow S discharges the heat inside the circulation space K2 to the outside of the outer lining 20, thereby cooling the circulation space K2, the inner lining 10 that is in contact with the circulation space, and the housing space K1 that is in contact with the inner lining 10.

Furthermore, the cooling device 40 can be operated by the operator or in accordance with the temperature of the inner lining 10 or the like. In that case, in the cooling device 40, the mist W is supplied to the circulation space K2 from the spraying device 41. The mist W cools the air circulating in the circulation space K2. Furthermore, in the cooling device 40, water is circulated in the piping inside the pad device 44. Therefore, the air passing through the ventilation part of the pad device 44 is cooled. As described, the cooling efficiency of the circulation space K2, the inner lining 10, and the housing space K1 is increased by the operation of the cooling device 40.

Furthermore, in the present embodiment, the inner lining 10 is sealed against the ground surface G such that there is no air flow generated to and from the outside. Therefore, even when the entire circulation space K2 comes to be in a negative pressure due to the operation of the air discharge unit 32, effluence of air from the inside of the inner lining 10 into the circulation space K2 is suppressed. This suppresses generation of air flow in the surrounding of the plants P in the housing space K1, thereby reducing the stress on the plants P.

As described above, the cultivation greenhouse 100 according to the present embodiment includes: the inner lining 10 that forms the housing space K1 for housing the plants P to be the cultivation target, and tightly seals the housing space K1; the outer lining 20 that is disposed on the outer side of the inner lining 10 to house the inner lining 10, and forms, with the inner lining 10, the circulation space K2 for flowing outside air; and the circulation device 30 that circulates air outside the outer lining 20 into the circulation space K2.

Therefore, since air outside the outer lining 20 is circulated into the circulation space K2 and the air is discharged to the outside of the outer lining 20, the heat within the circulation space K2 can be efficiently released to the outside of the outer lining 20. This makes it possible to suppress increase in the temperature of the circulation space K2, and to cool the inner lining 10 and the outer lining 20 that are in contact with the circulation space K2. In addition, since the housing space K1 is tightly sealed by the inner lining 10, it is possible to suppress air flow in the housing space K1. Therefore, the stress on the plants can be suppressed. As described, according to the present embodiment, it is possible to provide the cultivation greenhouse 100 that is capable of properly adjusting the internal temperature while suppressing the stress on the plants.

In the cultivation greenhouse 100 according to the present embodiment, the inner lining 10 and the outer lining 20 are provided to form the circulation space K2 between the ceiling part 10e of the inner lining 10 and the ceiling part 20e of the outer lining 20. Therefore, the heat in the inner lining 10 and the housing space K1 released from the ceiling part 10e of the inner lining 10 can be efficiently released to the outside of the outer lining 10.

In the cultivation greenhouse 100 according to the present embodiment, the circulation device 30 includes: the air intake unit 31 that draws air outside the outer lining 20 into the circulation space K2; and the air discharge unit 32 that discharges air inside the circulation space K2 to the outside. Therefore, intake of outside air into the circulation space K2 and discharge of outside air from the circulation space K2 can be performed efficiently.

The cultivation greenhouse 100 according to the present embodiment further includes the cooling device 40 that cools the air circulating in the circulation space K2. Therefore, the inside of the circulation space K2 can be cooled efficiently.

In the cultivation greenhouse 100 according to the present embodiment, the cooling device 40 supplies water on the path through which the air circulates. Therefore, it is possible to cool the air circulating in the circulation space K2 without complicating the device configuration.

In the cultivation greenhouse 100 according to the present embodiment, the cooling device 40 controls the supply amount of water in accordance with the temperature in the inner lining 10 or the housing space K1. Thus, it is possible to perform cooling operations by corresponding to the temperature of the inner lining 10 or the housing space K1.

In the cultivation greenhouse 100 according to the present embodiment, the inner lining 10 and the outer lining 20 transmit light of wavelengths that allow the plants P to photosynthesize. Therefore, as in a mode where the plants P are cultivated outdoors using natural light, it is possible to properly adjust the internal temperature while suppressing the stress on the plants P in an environment where light is drawn in from the outside of the cultivation greenhouse 100.

In the cultivation greenhouse 100 according to the present embodiment, the inner lining 10 includes the door 12 that is capable of being opened and closed, and the air curtain forming unit 13 that forms an air curtain at the opening area in a state where the door 12 is open is provided at a position along the door 12 of the inner lining 10 on the housing space K1 side. Thus, even in a state where the door 12 of the inner lining 10 is open, it is possible to suppress the air flow inside and outside of the inner lining 10.

### Second Embodiment

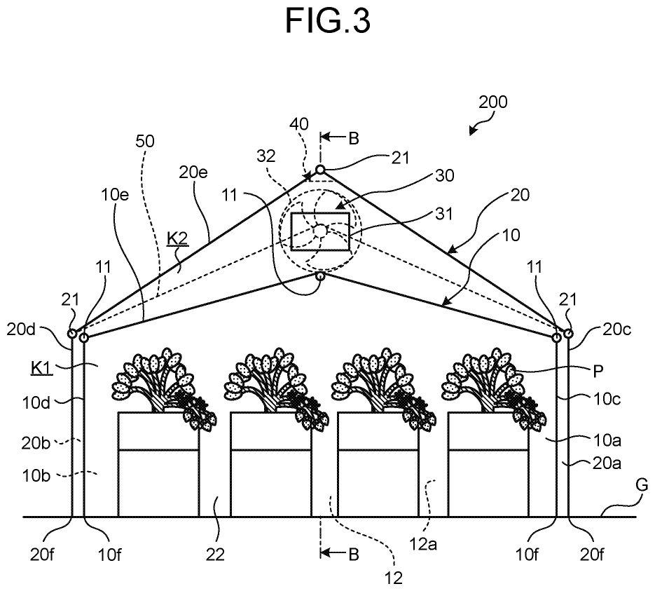

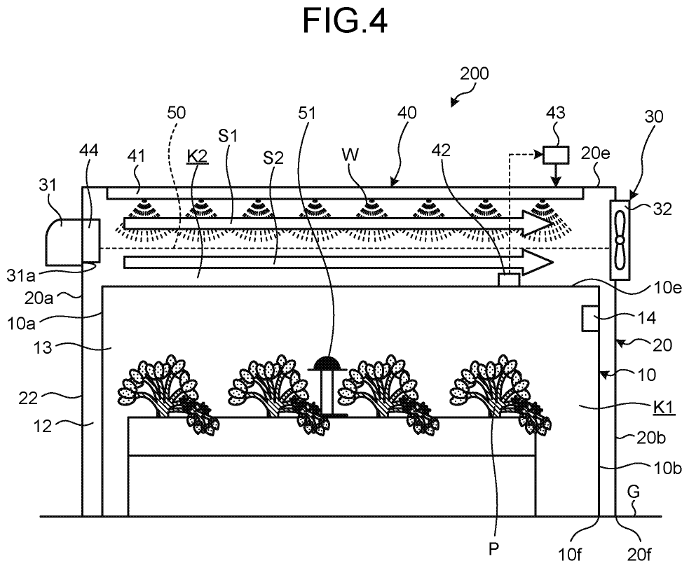

FIG. 3 is a front view illustrating an example of a cultivation greenhouse 200 according to a second embodiment. FIG. 4 is a sectional view of the example of the cultivation greenhouse 200, which illustrates a configuration taken along the B-B section in FIG. 3. The cultivation greenhouse 200 illustrated in FIG. 3 and FIG. 4 is a configuration that includes a light-shielding sheet 50 and a pyranometer 51 in addition to the configuration of the cultivation greenhouse 100 described in the first embodiment. The configuration other than those is the same as that of the first embodiment. In the second embodiment, the same reference signs are applied to the structural components same as those of the cultivation greenhouse 100 according to the first embodiment, and explanations thereof are omitted or simplified.

The light-shielding sheet 50 reflects or absorbs at least part of light such as sunlight. The light-shielding sheet 50 can be disposed between the inner lining 10 and the outer lining 20, for example. The light-shielding sheet 50 can be disposed at a position at an intermediate height between the ceiling part 10e of the inner lining 10 and the ceiling part 20e of the outer lining 20, but it is not limited to such a mode and other layout may be employed as well. For example, the light-shielding sheet 50 may be disposed outside the outer lining 20, such as above the ceiling part 20e of the outer lining 20. The light-shielding sheet 50 may be in a state covering at least part of the ceiling part 10e of the inner lining 10 or the ceiling part 20e of the outer lining 20 (hereinafter, referred to as a covered state), or may be in a state not covering the ceiling part 10e of the inner lining 10 or the ceiling part 20e of the outer lining 20 (hereinafter, an open state).

When the light-shielding sheet 50 is in the covered state, the irradiation amount of external light such as sunlight irradiated from the ceiling part 10e of the inner lining 10 to the housing space K1 is decreased compared to a case of the open state. Therefore, the amount of heat input into the housing space K1 can be suppressed by keeping the light-shielding sheet 50 in the covered state. When the light-shielding sheet 50 is in the covered state, an artificial light source may be disposed in the housing space K1 or the like, for example, to supplement the amount of light such as sunlight. Furthermore, the artificial light source may also be disposed when controlling sunshine hours at night or the like, when supplementing insufficient solar radiation due to weather conditions, and the like.

As a use mode of the light-shielding sheet 50, for example, the light-shielding sheet 50 may be left in the open state under a normal condition, and the light-shielding sheet 50 may be turned into the covered state in a case where the temperature of the inner lining 10 or the housing space K1 does not decrease sufficiently even by operating the circulation device 30 and the cooling device 40, such as when the temperature is hot in the summer season. Furthermore, as illustrated in FIG. 4, for example, the pyranometer 51 may be disposed in the housing space K1, and the open state and the covered state of the light-shielding sheet 50 may be switched based on the measurement result of the pyranometer 51.

When the light-shielding sheet 50 is in the covered state, air flows S1 and S2 are formed above and below the light-shielding sheet 50, respectively, by the circulation device 30. Therefore, even when the light-shielding sheet 50 is disposed, it is possible to efficiently release the heat in the circulation space K2 to the outside of the outer lining 20.

As described above, the cultivation greenhouse 200 according to the second embodiment further includes the light-shielding sheet 50 that is disposed in the circulation space K2 and is capable of covering at least part of the inner lining 10. Therefore, the amount of heat input into the housing space K1 can be suppressed by keeping the light-shielding sheet 50 in the covered state. Furthermore, even when the light-shielding sheet 50 is disposed, it is possible to efficiently release the heat in the circulation space K2 to the outside of the outer lining 20. This makes it possible to suppress increase in the temperature of the circulation space K2, and to cool the inner lining 10 and the outer lining 20 that are in contact with the circulation space K2. In addition, by disposing the light-shielding sheet 50 in the circulation space K2, the covered state and the open state can be easily changed, thereby preventing deterioration caused due to wind, rain, and the like.

### Third Embodiment

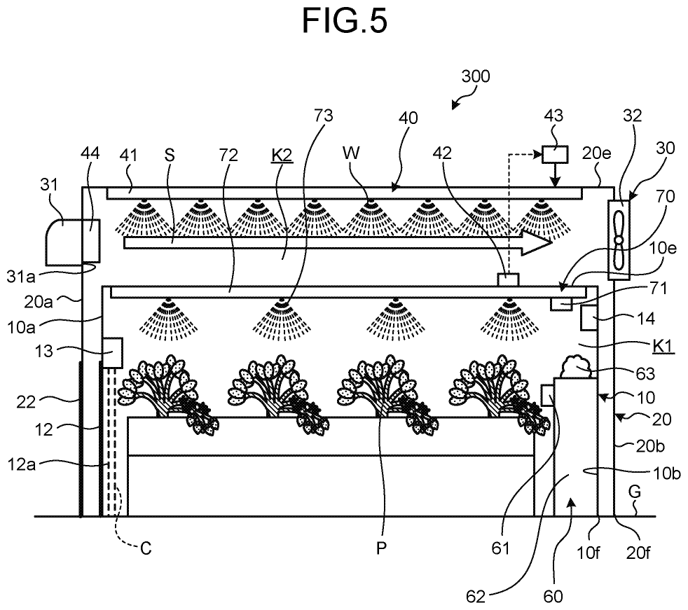

FIG. 5 is a sectional view illustrating an example of a cultivation greenhouse 300 according to a third embodiment. FIG. 5 is a sectional view corresponding to FIG. 2 of the first embodiment or FIG. 4 of the second embodiment. As illustrated in FIG. 5, the cultivation greenhouse 300 is a configuration that includes a concentration adjustment device 60 and a humidity adjustment device 70 in addition to the configuration of the cultivation greenhouse 100 described in the first embodiment. The configuration other than those is the same as that of the first embodiment. In the third embodiment, the same reference signs are applied to the structural components same as those of the cultivation greenhouse 100 according to the first embodiment, and explanations thereof are omitted or simplified.

The concentration adjustment device 60 adjusts the concentration of carbon dioxide in the housing space K1. The concentration adjustment device 60 includes a concentration detection unit 61 and a carbon dioxide supply unit 62. The concentration detection unit 61 detects the concentration of carbon dioxide in the housing space K1. The carbon dioxide supply unit 62 supplies a carbon dioxide gas 63 to the housing space K1 in accordance with the detection result of the concentration detection unit 61.

The humidity adjustment device 70 adjusts the humidity in the housing space K1. The humidity adjustment device 70 includes a humidity detection unit 71 and a moisture supply unit 72. The humidity detection unit 71 detects the humidity in the housing space K1. The moisture supply unit 72 supplies mist 73, which is water to be sprayed, for example, to the housing space K1 in accordance with the detection result of the humidity detection unit 71.

As described above, the cultivation greenhouse 300 according to the third embodiment includes the concentration adjustment device 60 that includes the concentration detection unit 61 and the carbon dioxide supply unit 62. Thus, the concentration of carbon dioxide in the housing space K1 can be adjusted properly. Furthermore, the humidity adjustment device 70 that includes the humidity detection unit 71 and the moisture supply unit 72 is also provided. Thus, the humidity in the housing space K1 can be adjusted appropriately.

### Fourth Embodiment

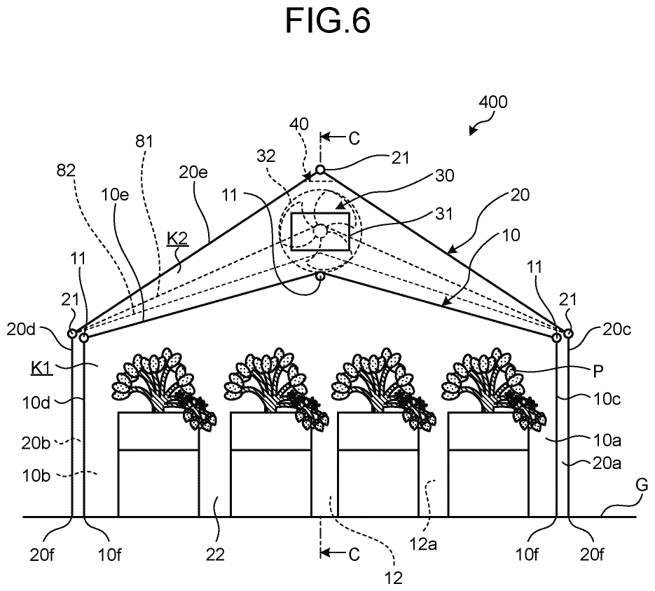

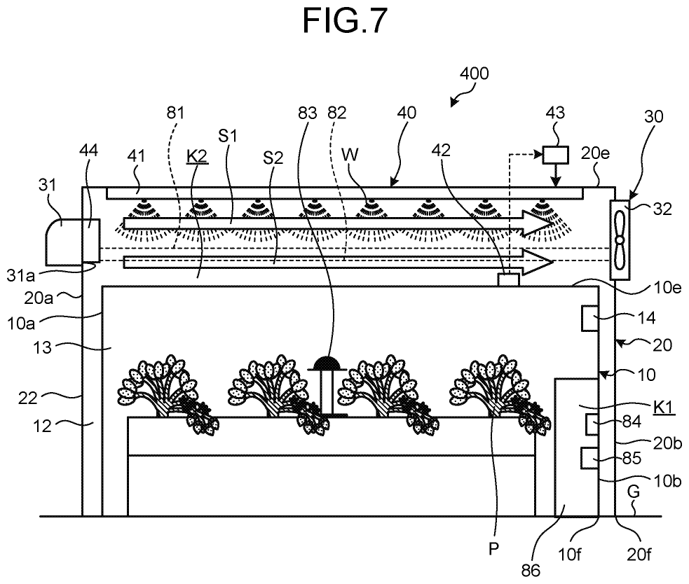

FIG. 6 is a front view illustrating an example of a cultivation greenhouse 400 according to a fourth embodiment. FIG. 7 is a sectional view of the example of the cultivation greenhouse 400, which illustrates a configuration taken along the C-C section in FIG. 6. The cultivation greenhouse 400 illustrated in FIG. 6 and FIG. 7 is a configuration that includes light-shielding sheets 81, 82, a pyranometer 83, a concentration detection unit 84, a light-shielding control unit 85 in addition to the configuration of the cultivation greenhouse 100 described in the first embodiment. Furthermore, the cultivation greenhouse 400 is a configuration that includes a carbon dioxide supply unit 86 that supplies carbon dioxide to the housing space K1. The configuration other than those is the same as that of the first embodiment. In the fourth embodiment, the same reference signs are applied to the structural components same as those of the cultivation greenhouse 100 according to the first embodiment, and explanations thereof are omitted or simplified.

In the present embodiment, the light-shielding sheets 81 and 82 reflect or absorb at least part of light such as sunlight. An infrared cut film, for example, can be used for at least one of the light-shielding sheets 81 and 82. In that case, as the light-shielding sheets 81 and 82, it is possible to use sheets where the transmittance of the wavelength corresponding to infrared light is set to be smaller than the transmittance of the other range of wavelengths. This configuration can efficiently cut infrared rays unnecessary for photosynthesis, so that it is possible to suppress increase in the temperature in the housing space K1 and to decrease the load on the air conditioning device 14. In a case where a plurality of light-shielding sheets are provided, at least one of the light-shielding sheets may be a sheet whose transmittance of the wavelength corresponding to infrared light is set to be smaller than the transmittance of the other range of wavelengths. The pyranometer 83 measures the amount of solar radiation incident on the housing space K1. The pyranometer 83 transmits the measurement result to the light-shielding control unit 85. The concentration detection unit 84 detects the concentration of carbon dioxide in the housing space K1. Note that the concentration detection unit 84 transmits the detection result to the light-shielding control unit 85. The light-shielding control unit 85 controls the light-shielding states of the light-shielding sheets 81 and 82. The carbon dioxide supply unit 86 supplies carbon dioxide to the housing space K1 such that the concentration of carbon dioxide in the housing space K1 becomes constant based on the detection result of the concentration detection unit 84. The carbon dioxide supply unit 86 transmits the value of the supply amount of carbon dioxide that is supplied to the housing space K1 to the light-shielding control unit 85.

The light-shielding sheets 81 and 82 can be disposed between the inner lining 10 and the outer lining 20, for example. The light-shielding sheets 81 and 82 can be disposed at positions at an intermediate height between the ceiling part 10e of the inner lining 10 and the ceiling part 20e of the outer lining 20, but it is not limited to such a mode and other layout may be employed as well. For example, the light-shielding sheets 81 and 82 may be disposed outside the outer lining 20, such as above the ceiling part 20e of the outer lining 20.

In the present embodiment, the light-shielding sheets 81 and 82 are provided in multiple stages between the ceiling part 10e of the inner lining 10 and the ceiling part 20e of the outer lining 20. The light-shielding sheet 81 and the light-shielding sheet 82 have different light-shielding rates from each other. In the present embodiment, the light-shielding sheet 82 has a greater light-shielding rate than that of the light-shielding sheet 81. While FIG. 6 and FIG. 7 illustrate an example of a configuration in which the light-shielding sheet 81 is disposed on the outer lining 20 side and the light-shielding sheet 82 is disposed on the inner lining 10 side, the configuration is not limited thereto. It is also possible to employ a configuration in which the light-shielding sheet 81 is disposed on the inner lining 10 side and the light-shielding sheet 82 is disposed on the outer lining 20 side.

When the light-shielding sheets 81 and 82 are in a covered state, the intensity of irradiation of external light such as sunlight irradiated from the ceiling part 10e of the inner lining 10 to the housing space K1 is decreased compared to a case of an open state. Therefore, the amount of heat input into the housing space K1 can be suppressed by keeping the light-shielding sheets 81 and 82 in the covered state.

The light-shielding sheets 81 and 82 can be switched, for example, between a state where the inner lining 10 is covered (a covered state) and a state where the inner lining 10 is not covered (hereafter, an open state). By switching the covered state and the open state in each of the light-shielding sheets 81 and 82, the light-shielding state of the inner lining 10 is switched. In other words, the light-shielding state of the inner lining 10 is switched among a first state where both light-shielding sheets 81 and 82 are in the open state, a second state where the light-shielding sheet 81 is in the covered state and the light-shielding sheet 82 is in the open state, a third state where the light-shielding sheet 81 is in the open state and the light-shielding sheet 82 is in the covered state, and a fourth state where both light-shielding sheets 81 and 82 are in the covered state. In that case, the light-shielding rate gradually increases from the first state to the fourth state.

The light-shielding sheets 81 and 82 are configured such that the covered state and the open state are switched by, for example, a sheet drive unit, not illustrated. Therefore, through controlling the sheet drive unit by the light-shielding control unit 85, it is possible to automatically switch the light-shielding states of the light-shielding sheets 81 and 82 between the covered state and the open state.

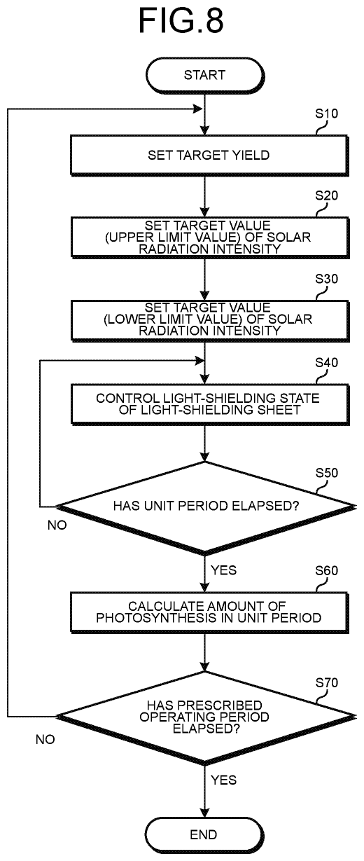

Hereinafter, an example of the control of the light-shielding states of the light-shielding sheets 81 and 82 performed by the light-shielding control unit 85 will be described. FIG. 8 is a flowchart illustrating a flow of the control performed by the light-shielding control unit 85. As illustrated in FIG. 8, a target yield of the plants P is set (Step S10). As the target yield, it is possible to set the target yield over the course of a plurality of unit periods (for example, one month, one quarter, one year, or the like), for example. For example, at the first timing of the unit periods, the operator can set a target yield. Furthermore, after the target yield is set for the unit periods, the light-shielding control unit 85 sets the target yield every time the unit period elapses. In that case, assuming that the target yield in the previous elapsed unit period (for example, the previous day) is R1, the actual yield in that previous unit period is R2, and the target yield set at the first timing of the unit periods is R3, the light-shielding control unit 85 can set the following value R

R=R1−R2+R3

as the target yield R of the next unit period.

Note that the actual yield R2 in a unit period is correlated with the amount of photosynthesis in that unit period. Furthermore, when the carbon dioxide concentration is controlled to be constant, for example, the amount of photosynthesis in a unit period is correlated with the supply amount of carbon dioxide that is supplied to the housing space K1 during the unit period. Therefore, when the concentration of carbon dioxide is controlled to be constant, by acquiring in advance the correlation regarding the supply amount of carbon dioxide supplied to the housing space K1 during the unit period, the amount of photosynthesis, and the actual yield, it is possible to calculate the actual yield R2 based on the supply amount 84 of carbon dioxide supplied to the housing space K1 during the unit period. Note that the correlation mentioned above can be stored in a storage unit, not illustrated.

Next, the light-shielding control unit 85 sets the target value of the intensity of solar radiation for the next unit period in accordance with the set target yield (Steps S20 and S30). The amount of solar radiation in a unit period is correlated with the yield of the plants P in that unit period. Based on the solar radiation forecast for the next unit period, the light-shielding control unit 85 sets the target value of the intensity of solar radiation such that the amount of solar radiation corresponding to the target yield in that unit period makes incident on the housing space K1. In the present embodiment, the light-shielding control unit 85 can set target values as the upper limit value and the lower limit value of the intensity of solar radiation. When the difference between the upper limit value and the lower limit value is set too narrow, for example, the light-shielding sheets 81 and 82 are to be adjusted even in a case where the amount of solar radiation changes slightly due to disturbances such as small clouds hanging over the sun, for example. For that reason, a certain amount of difference is to be ensured between the upper limit value and the lower limit value. For example, by setting such a difference in advance, when the upper limit value of the target value of the intensity of solar radiation is set, the lower limit value can be set automatically based on the upper limit value and the difference set in advance.

When the next unit period starts, the light-shielding control unit 85 controls the light-shielding states of the light-shielding sheets 81 and 82 such that the intensity of solar radiation measured by the pyranometer 83 becomes equal to or lower than the upper limit value and equal to or higher than the lower limit value of the intensity of solar radiation set in the above (Step S40).

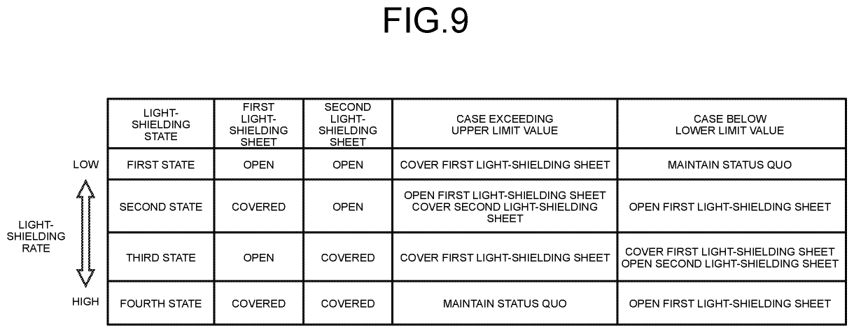

The light-shielding control unit 85 can control the light-shielding states of the light-shielding sheets 81 and 82 as indicated in FIG. 9, for example. FIG. 9 is a table indicating examples of the light-shielding states as well as the control contents of the light-shielding sheets 81 and 82. In FIG. 9, the light-shielding sheet 81 is denoted as a first light-shielding sheet, and the light-shielding sheet 82 is denoted as a second light-shielding sheet.

As indicated in FIG. 9, when the intensity of solar radiation exceeds the upper limit value in the first state, the light-shielding sheet 81 is brought to be in a covered state to be in the second state. When the intensity of solar radiation exceeds the upper limit value in the second state, the light-shielding sheet 81 is brought to be in an open state and the light-shielding sheet 82 is brought to be in a covered state to be in the third state. When the intensity of solar radiation exceeds the upper limit value in the third state, the light-shielding sheet 82 is brought to be in a covered state to be in the fourth state. When the intensity of solar radiation exceeds the upper limit value in the fourth state, the fourth state is maintained as it is.

In the meantime, when the intensity of solar radiation is below the lower limit value in the fourth state, the light-shielding sheet 81 is brought to be in an open state to be in the third state. When the intensity of solar radiation is below the lower limit value in the third state, the light-shielding sheet 81 is brought to be in a covered state and the light-shielding sheet 82 is brought to be in an open state to be in the second state. When the intensity of solar radiation is below the lower limit value in the second state, the light-shielding sheet 81 is brought to be in an open state to be in the first state. When the intensity of solar radiation is below the lower limit value in the first state, the first state is maintained as it is.

The light-shielding control unit 85 determines whether the unit period has elapsed (Step S50). When determined that the unit period has not elapsed (No at Step S50), the light-shielding control unit 85 continues the control of Step S40. When determined that the unit period has elapsed (Yes at Step S50), the light-shielding control unit 85 calculates the amount of photosynthesis of the plants P during that unit period based on the detection result of the concentration detection unit 84 (Step S60).

After calculating the amount of photosynthesis, the light-shielding control unit 85 determines whether a prescribed operating period has elapsed (Step S70). When determined that the prescribed operating period has not elapsed (No at Step S70), the light-shielding control unit 85 repeats the processing from Step S10 and thereafter. In that case, the target yield for the next unit period is set based on the amount of photosynthesis calculated at Step S60. In the meantime, when determined that the prescribed operating period has elapsed (Yes at Step S70), the light-shielding control unit 85 ends the processing.

As described above, the cultivation greenhouse 400 according to the fourth embodiment further includes the light-shielding sheets 81 and 82 that are disposed in the circulation space and decrease the intensity of solar radiation incident on the housing space K1 by covering at least part of the inner lining. Therefore, the amount of heat input into the housing space K1 can be suppressed by keeping the light-shielding sheets 81 and 82 in the covered state.

Furthermore, in the cultivation greenhouse 400 according to the fourth embodiment, the light-shielding sheets 81 and 82 are provided in multiple stages between the inner lining 10 and the outer lining 20, and the light-shielding sheets 81 and 82 in the multiple stages have different light-shielding rates from each other. Therefore, it is possible with the light-shielding sheets 81 and 82 to form four different light-shielding states from the first state to the fourth state.

Also, the cultivation greenhouse 400 according to the fourth embodiment further includes the light-shielding control unit 85 that controls the light-shielding states of the light-shielding sheets 81 and 82. This makes it possible to automatically switch the light-shielding states of the light-shielding sheets 81 and 82.

Furthermore, the cultivation greenhouse 400 according to the fourth embodiment further includes: the concentration detection unit 84 that detects the concentration of carbon dioxide in the housing space K1; and the carbon dioxide supply unit 86 that supplies carbon dioxide to the housing space K1 in accordance with the detection result of the concentration detection unit 84. The light-shielding control unit 85: calculates the amount of photosynthesis of the plants P in a unit period based on the supply amount of the carbon dioxide supplied in the unit period; calculates a target yield of the plants P in a next unit period based on the calculated amount of photosynthesis; and controls the light-shielding states of the light-shielding sheets 81 and 82 based on the calculated target yield. Therefore, changes in the concentration of carbon dioxide can be detected with high precision by the cultivation greenhouse 400 in a closed structure, so that it is possible to control the light-shielding states of the light-shielding sheets 81 and 82 with high precision based on the amount of photosynthesis and the target yield calculated based on the changes in the concentration of the carbon dioxide.

Furthermore, in the cultivation greenhouse 400 according to the fourth embodiment, the light-shielding control unit 85 controls the light-shielding states of the light-shielding sheets 81 and 82 so as not to exceed the threshold of the intensity of solar radiation set in advance. Therefore, it is possible to reduce the load required for temperature control of the air conditioning device 14 and the like, and secure the yield efficiently. Furthermore, in the cultivation greenhouse 400 according to the fourth embodiment, the cooling device 40 for cooling the air circulating in the circulation space K2 is provided. Therefore, increase in the temperature in the housing space K1 can be efficiently suppressed by the cooling device 40, so that the threshold can be set higher. Note that the cooling device 40 may not be provided in the fourth embodiment.

Furthermore, in the cultivation greenhouse 400 according to the fourth embodiment, at least one of the light-shielding sheets 81 and 82 is set such that the transmittance of the wavelength corresponding to infrared light becomes smaller than the transmittance of the other range of wavelengths. As a result, infrared light unnecessary for photosynthesis can be cut efficiently, so that it is possible to suppress increase in the temperature in the housing space K1. In a case where the air conditioning device 14 is provided, the load on the air conditioning device 14 can be reduced.

### Reference Signs List

10 Inner lining

10a, 20a Front face part

10b, 20b Rear face part

10c, 10d, 20c, 20d Side face part

10e, 20e Ceiling part

10f, 20f Lower end

11, 21 Frame

12, 22 Door

12a Opening area

13 Air curtain forming unit

14 Air conditioning device

20 Outer lining

30 Circulation device

31 Air intake unit

31a Opening part

32 Air discharge unit

40 Cooling device

41 Spraying device

42 Temperature detection unit

43 Supply control unit

44 Pad device

50, 81, 82 Light-shielding sheet

51, 83 Pyranometer

60 Concentration adjustment device

61, 84 Concentration detection unit

62, 86 Carbon dioxide supply unit

63 Carbon dioxide gas

70 Humidity adjustment device

71 Humidity detection unit

72 Moisture supply unit

73, W Mist

85 Light-shielding control unit

100, 200, 300, 400 Cultivation greenhouse

C Air curtain

K1 Housing space

K2 Circulation space

P Plant

1. A cultivation greenhouse comprising:
an inner lining that forms a housing space for housing a plant to be a cultivation target, the inner lining tightly sealing the housing space;
an outer lining that is disposed on an outer side of the inner lining to house the inner lining, the outer lining forming, with the inner lining, a circulation space for flowing outside air;
a circulation device that circulates air outside the outer lining into the circulation space and discharges the air to outside of the outer lining;
two light-shielding sheets disposed one above another between the inner lining and the outer lining, each light-shielding sheet decreasing an intensity of solar radiation incident on the housing space by covering at least part of the inner lining; and
a light-shielding control unit that switches a light-shielding state of each light-shielding sheet between a covered state of covering at least part of a ceiling part of the inner lining or a ceiling part of the outer lining and an open state of not covering the ceiling part of the inner lining or the ceiling part of the outer lining,
wherein
the inner lining and the outer lining are provided such that the circulation space is formed between a ceiling part of the inner lining and a ceiling part of the outer lining, and
the light-shielding control unit sets target values as an upper limit value and a lower limit value of the intensity of solar radiation based on a target yield of the plant, and controls the light-shielding state of each light-shielding sheet so that the intensity of solar radiation is equal to or lower than the upper limit value and equal to or higher than the lower limit value.

2. (canceled)

3. The cultivation greenhouse according to claim 1, wherein the circulation device includes an air intake unit that draws air outside the outer lining into the circulation space, and an air discharge unit that discharges air inside the circulation space to outside.

4. The cultivation greenhouse according to claim 1, further comprising a cooling device that cools the air circulating in the circulation space.

5. The cultivation greenhouse according to claim 4, wherein the cooling device supplies water on a path where the air circulates.

6. The cultivation greenhouse according to claim 5, wherein the cooling device controls a supply amount of the water in accordance with a temperature in the inner lining or the housing space.

7. The cultivation greenhouse according to claim 1, wherein the inner lining and the outer lining transmit light of wavelengths that allow the plant to photosynthesize.

8. The cultivation greenhouse according to claim 1, wherein the inner lining includes a door capable of being opened and closed, and an air curtain forming unit that forms an air curtain at an opening area in a state where the door is open is provided at a position along the door of the inner lining on the housing space side.

9. (canceled)

10. (canceled)

11. (canceled)

12. The cultivation greenhouse according to claim 1, further comprising:
a concentration detection unit that detects a concentration of carbon dioxide in the housing space; and
a carbon dioxide supply unit that supplies carbon dioxide to the housing space in accordance with a detection result of the concentration detection unit, wherein
the light-shielding control unit
calculates an amount of photosynthesis of the plant in a unit period based on an supply amount of the carbon dioxide supplied in the unit period,
calculates a target yield of the plant in a next unit period of the unit period based on the calculated amount of photosynthesis, and
controls the light-shielding state of each light-shielding sheet based on the calculated target yield.

13. (canceled)

14. The cultivation greenhouse according to claim 1, wherein at least one of the light-shielding sheets is set such that transmittance of a wavelength corresponding to infrared light is set to be smaller than transmittance of other range of wavelengths.

15. The cultivation greenhouse according to claim 1, further comprising:
a concentration detection unit that detects a concentration of carbon dioxide in the housing space; and
a carbon dioxide supply unit that supplies carbon dioxide to the housing space in accordance with a detection result of the concentration detection unit.

16. The cultivation greenhouse according to claim 1, further comprising:
a humidity detection unit that detects a humidity in the housing space; and
a moisture supply unit that supplies moisture to the housing space in accordance with a detection result of the humidity detection unit.

17. The cultivation greenhouse according to claim 1, wherein
the light-shielding sheets include a first light-shielding sheet disposed on the outer lining side and a second light-shielding sheet disposed on the inner lining side, the second light-shielding sheet having a light-shielding rate higher than the first light-shielding sheet, and
the light-shielding control unit controls the light-shielding states of the light-shielding sheet to enter a first state in which both the first light-shielding sheet and the second light-shielding sheet are in the open state, a second state in which both the first light-shielding sheet is in the covered state and the second light-shielding sheet is in the open state, a third state in which both the first light-shielding sheet is in the open state and the second light-shielding sheet is in the covered state, or a fourth state in which both the first light-shielding sheet and the second light-shielding sheet are in the covered state.

18. The cultivation greenhouse according to claim 17, wherein
when the light-shielding states are in the first state and the intensity of solar radiation is higher than the upper limit value, the light-shielding control unit changes the light-shielding state of the first light-shielding sheet to the covered state to enter the second state,
when the light-shielding states are in the second state and the intensity of solar radiation is higher than the upper limit value, the light-shielding control unit changes the light-shielding state of the first light-shielding sheet to the open state to enter the third state,
when the light-shielding states are in the third state and the intensity of solar radiation is higher than the upper limit value, the light-shielding control unit changes the light-shielding state of the first light-shielding sheet to the covered state to enter the fourth state, and
when the light-shielding states are in the fourth state and the intensity of solar radiation is higher than the upper limit value, the light-shielding control unit maintains the light-shielding states at the fourth state.

19. The cultivation greenhouse according to claim 17, wherein
when the light-shielding states are in the fourth state and the intensity of solar radiation is lower than the lower limit value, the light-shielding control unit changes the light-shielding state of the first light-shielding sheet to the open state to enter the third state,
when the light-shielding states are in the third state and the intensity of solar radiation is lower than the lower limit value, the light-shielding control unit changes the light-shielding state of the first light-shielding sheet to the covered state and the light-shielding state of the second light-shielding sheet to the open state to enter the second state,
when the light-shielding states are in the second state and the intensity of solar radiation is lower than the lower limit value, the light-shielding control unit changes the light-shielding state of the first light-shielding sheet to the open state to enter the first state, and
when the light-shielding states are in the first state and the intensity of solar radiation is lower than the lower limit value, the light-shielding control unit maintains the light-shielding states at the first state.
